(19) United States
(12) Patent Application Publication
(10) Pub. No.: US 2014/0345719 A1
(43) Pub. Date: Nov. 27, 2014

(54) STRAINER AND FUEL PUMP MODULE HAVING THE SAME

(71) Applicant: COAVIS, Yeongi-gun (KR)

(72) Inventors: Jeong Sik KIM, Daejeon (KR); Woo Keun LEE, Daejeon (KR); Du Hyun KIM, Miryang-si (KR); Eun Ju LEE, Sejong-si (KR)

(73) Assignee: COAVIS, Yeongi-gun (KR)

(21) Appl. No.: 14/283,553

(22) Filed: May 21, 2014

(30) Foreign Application Priority Data
May 23, 2013 (KR) 10-2013-0058095

(51) Int. Cl. F02M 37/14

(52) U.S. Cl. CPC F02M 37/14
USPC 137/544; 210/460

(57) ABSTRACT

Provided are a strainer and a fuel pump module having the same, and more particularly, a strainer capable of preventing filter paper from stopping since the filter paper contacts each other at a portion at which the strainer is folded, in the strainer connected to an inlet of a fuel pump or a fuel pump module to filter fuel sucked thereinto, and a fuel pump module having the same.

### CROSS-REFERENCE TO RELATED APPLICATIONS

This application claims priority under 35 U.S.C. §119 to Korean Patent Application No. 10-2013-0058095, filed on May 23, 2013, in the Korean Intellectual Property Office, the disclosure of which is incorporated herein by reference in its entirety.

### TECHNICAL FIELD

The present invention relates to a strainer and a fuel pump module having the same, and more particularly, to a strainer capable of preventing a filter paper from stopping since the filter paper contacts each other at a portion at which the strainer is folded, in the strainer connected to an inlet of a fuel pump or a fuel pump module to filter fuel sucked thereinto, and a fuel pump module having the same.

### BACKGROUND

An apparatus such as a vehicle which is driven by being supplied with liquid fuel such as a gasoline engine and a diesel engine is provided with a fuel tank and the fuel tank is provided with a fuel pump module, in which the fuel pump module is configured to be connected to the engine via a fuel supply line to supply fuel stored inside the fuel tank to the engine. In this case, a fuel inlet of the fuel pump module is provided with a strainer which primarily filters the fuel inside the fuel tank to be sucked into a fuel pump which is disposed inside the fuel pump module.

As illustrated in FIGS. 1 and 2, a strainer 4 is disposed at a fuel inlet 3a of a fuel pump 3 which is disposed inside a fuel tank 1 and in the strainer 4, to prevent a phenomenon that the filtering is not made since the filter paper 4b contacts each other at the time of the suction of fuel, a rib 4c which is provided with a plurality of protruding parts is inserted into or combined with the filter paper 4b.

However, the strainer is formed to be folded as occasion demands, and an upper filter paper and a lower filter paper contacts each other at the folded portion and thus the fuel may not be filtered or the filtered foreign materials are deposited at the folded portion of the filter paper and thus the filter paper may stop. Further, to design the strainer so that the strainer is folded at a desired portion, the rib needs to be added with the plurality of protrusions and thus the design of the strainer may be complicated.

As the related art, there is Korean Utility Model Laid-Open Publication No. 20-1989-010861 entitled “in tank type fuel pump”.

### RELATED ART DOCUMENT

### Patent Document

(Patent Document 1) KR 20-1989-010861 U (Jul. 11, 1989)

### SUMMARY

An exemplary embodiment of the present invention is directed to providing a strainer capable of preventing an upper filter paper and a lower filter paper from contacting each other at a folded portion of the strainer to prevent a deposition of filtered materials and a stoppage of the filter paper at the folded portion and a fuel pump module having the same.

In one general aspect, there is provided a strainer including: a filter paper 100 filtering fuel and having a space part 130 disposed therein; an upper rib 210 combined with an outer upper portion of the filter paper 100; a plurality of protruding parts 300 protruding down from the upper rib 210 to be disposed inside the filter paper 100; and a communicating pipe 400 combined with the filter paper 100 to communicate with the space part 130 of the filter paper 100, wherein the filter paper 100 and the upper rib 210 are partially folded up longitudinally, and the upper and lower portions of the filter paper 100 are formed not to contact each other at the folded portion.

The strainer may further include: a lower rib 220 combined with the outer lower portion of the filter paper 100; and the plurality of protruding parts 300 protruding up from the lower rib 220 to be disposed inside the filter paper 100; wherein the filter paper 100, the upper rib 210, and the lower rib 220 are partially folded longitudinally and thus the upper and lower portions of the filter paper 100 are formed not to contact each other at the folded portion.

The upper rib 210 and the lower rib 220 may be disposed in parallel to be spaced apart from each other in the width direction of the filter paper 100 and the upper rib 210 and the lower rib 220 may be alternately disposed.

Widths W of the protruding parts may be each formed differently and distances D between the protruding parts may be each formed differently, and the width W of the protruding part and the distance D between the protruding parts may be more narrowly formed at the portion at which the filter paper is folded than at the portion at which the filter paper is not folded.

In another general aspect, there is provided a strainer 1000 including: a filter paper 100 filtering fuel and having a space part 130 disposed therein; an inner rib 230 disposed inside the filter paper 100; a plurality of protruding parts 300 protruding up and down from the inner rib 230 to be disposed inside the filter paper 100; and a communicating pipe 400 combined with the filter paper 100 to communicate with the space part 130 of the filter paper 100, wherein the filter paper 100 and the inner rib 230 are partially folded up longitudinally, and the upper and lower portions of the filter paper 100 are formed not to contact each other at the folded portion.

Widths W of the protruding parts may be each formed differently and distances D between the protruding parts may be each formed differently, and the width W of the protruding part and the distance D between the protruding parts may be more narrowly formed at the portion at which the filter paper is folded than at the portion at which the filter paper is not folded.

In still another general aspect, there is provided a fuel pump module 2000 including: the strainer 1000 as described above, wherein the strainer 1000 is disposed inside a reservoir body 1200 in a partially folded state and a communicating pipe 400 of the strainer 1000 is connected to an inlet 1110 of the fuel pump 1100 which is disposed inside the reservoir body 1200.

### BRIEF DESCRIPTION OF THE DRAWINGS

FIGS. 1 and 2 are cross-sectional views illustrating a strainer and a fuel pump module according to the related art.

FIG. 3 is a cross-sectional view illustrating a strainer according to a first exemplary embodiment of the present invention.

FIGS. 4 and 5 are a cross-sectional view and a perspective view illustrating a state in which the strainer of FIG. 3 is folded.

FIG. 6 is a cross-sectional view illustrating a strainer according to a second exemplary embodiment of the present invention.

FIGS. 7 and 8 are a cross-sectional view and a perspective view illustrating a state in which the strainer of FIG. 6 is folded.

FIG. 9 is a cross-sectional view illustrating a strainer according to a third exemplary embodiment of the present invention.

FIG. 10 is a cross-sectional view and a perspective view illustrating a state in which the strainer of FIG. 9 is folded.

FIG. 11 is a perspective view illustrating an example in which the strainer according to the third exemplary embodiment of the present invention is modified.

FIG. 12 is a schematic cross-sectional view illustrating a fuel pump module having the strainer according to the exemplary embodiment of the present invention.

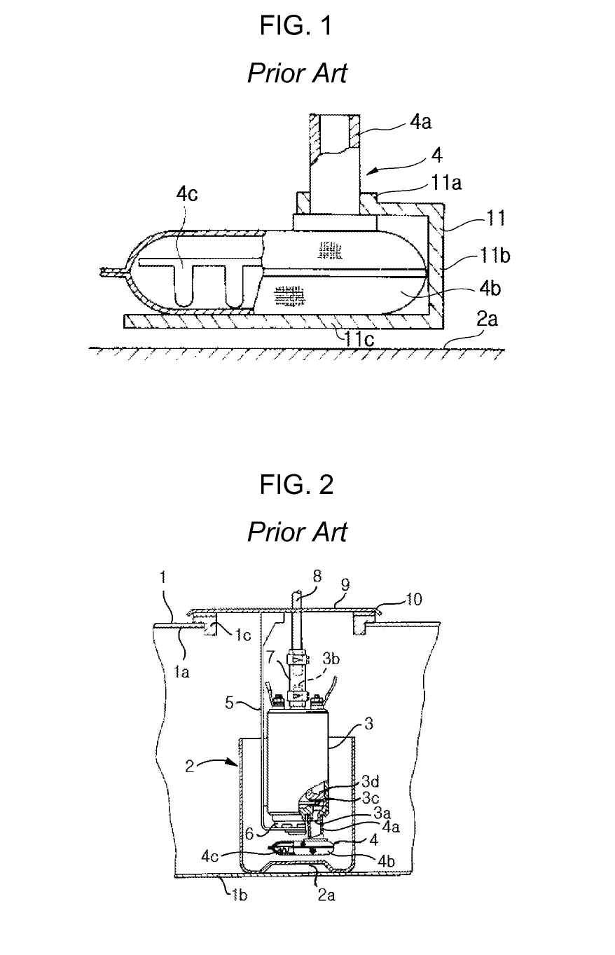

[Detailed Description of Main Elements]

| | |
|---|---|
| 1000: Strainer | |
| 100: Filter paper | |
| 110: Upper filter paper | 120: Lower filter paper |
| 130: Space part | |
| 210: Upper rib | 220: Lower rib |
| 230: Inner rib | 240: Connection rib |
| 300: Protruding part | |
| 400: Communicating pipe | |
| 1100: Fuel pump | 1110: Inlet |
| 1200: Reservoir body | |
| 2000: Fuel pump module | |
| W: Width of protruding part | |
| D: Distance between protruding parts | |

### DETAILED DESCRIPTION OF EMBODIMENTS

Hereinafter, a strainer and a fuel pump module having the same according to exemplary embodiments of the present invention will be described in detail with reference to the accompanying drawings.

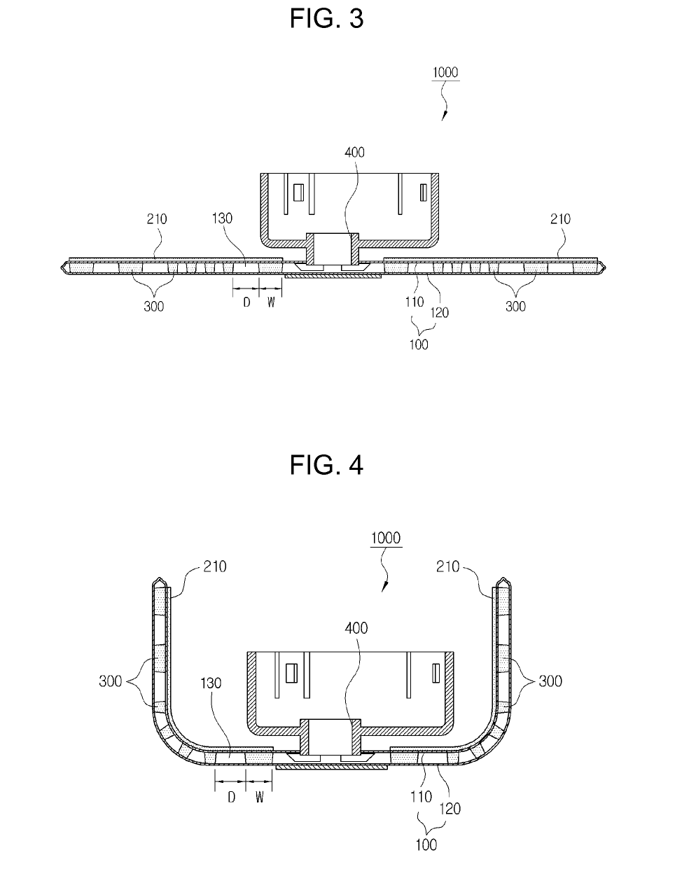

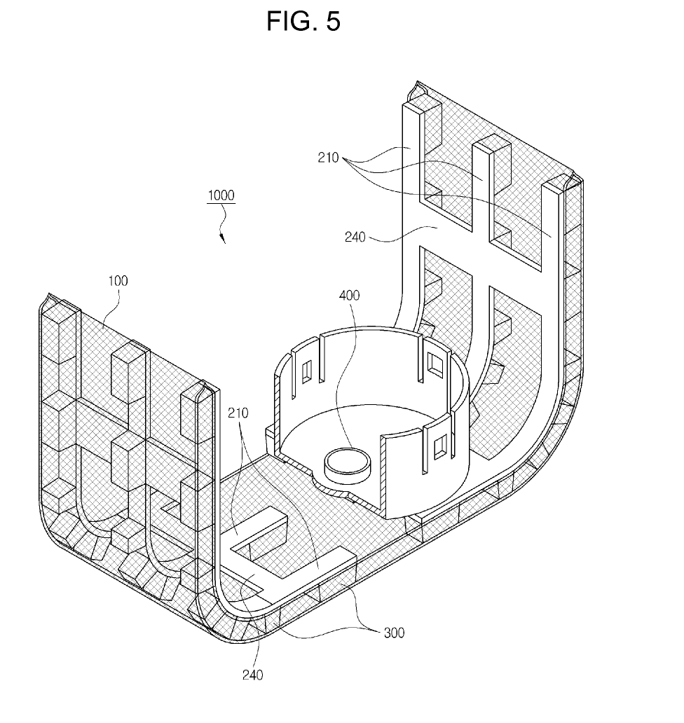

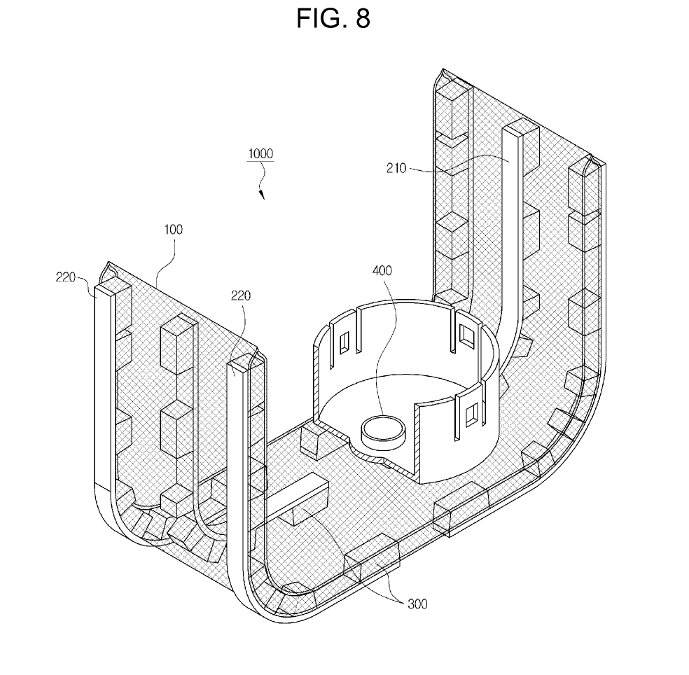

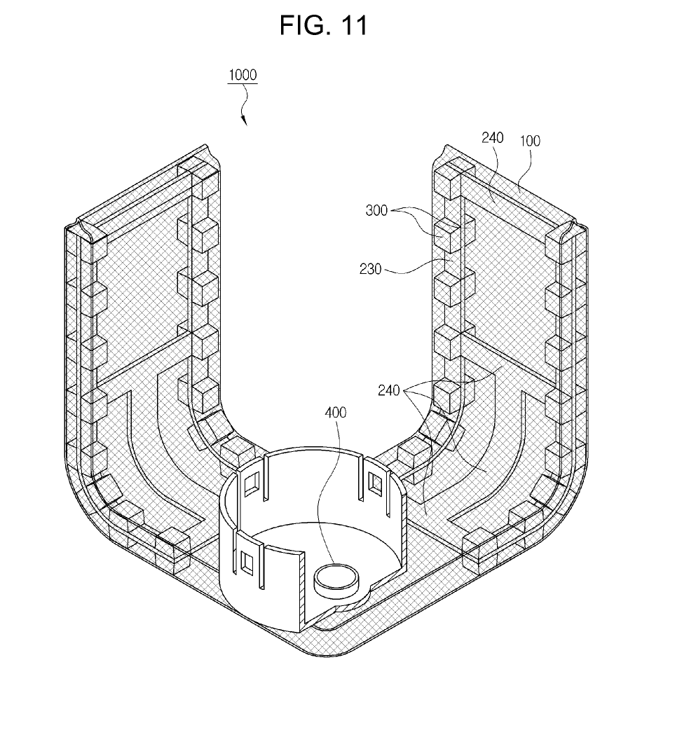

FIGS. 3 to 11 are cross-sectional views of a strainer according to an exemplary embodiment of the present invention and are a cross-sectional view and a perspective view illustrating a state in which the strainer is folded.

First, as illustrated in FIGS. 3 to 5, a strainer 1000 according to a first exemplary embodiment of the present invention includes: a filter paper 100 filtering fuel and having a space part 130 disposed therein; an upper rib 210 combined with an outer upper portion of the filter paper 100; a plurality of protruding parts 300 protruding down from the upper rib 210 to be disposed inside the filter paper 100; and a communicating pipe 400 combined with the filter paper 100 to communicate with the space part 130 of the filter paper 100, in which the filter paper 100 and the upper rib 210 are partially folded longitudinally and thus an upper portion and a lower portion of the filter paper 100 are formed not to contact each other at the folded portion.

The filter paper 100 is a portion at which fuel is filtered and may be formed in a thin mesh form. Further, the filter paper 100 is configured of an upper filter paper 110 and a lower filter paper 120 spaced apart from each other so as to have the space part 130 formed therein and edges of the upper filter paper 110 and the lower filter paper 120 are combined with each other by a welding method, and the like and thus edge portions are sealed.

The upper rib 210 is combined with an upper surface of the upper filter paper 110 which is the outer upper portion of the filter paper 100. In this configuration, the upper rib 210 is formed in a long bar shape and thus may adhere to the upper surface of the upper filter paper 110. Meanwhile, the upper rib 210 is formed in plural, in which the plurality of upper ribs 210 may be formed in parallel to be spaced apart from each other in a width direction. Further, when the upper rib 210 is formed in plural, a connection rib 240 which connects between the upper ribs 210 may also be formed. Therefore, the upper rib 210 is combined with the outer upper portion of the filter paper 100 and serves to maintain the form of the filter paper 100.

The protruding part 300 protrudes down from the upper rib 210 and is disposed in the space part 130 which is the inside of the filter paper 100. In this case, the protruding part 300 is formed in plural, in which the plurality of protruding parts 300 are formed along the upper rib 210, being spaced apart from each other. Further, a lower end of the protruding part 300 is formed up to the upper surface of the lower filter paper 120 to maintain a distance between the upper filter paper 110 and the lower filter paper 120.

In this case, the upper filter paper 110, the upper rib 210, and the protruding part 300 are made of a plastic resin material and the upper rib 210 and the protruding part 300 are injection molded together, having the upper filter paper 110 disposed therebetween, such that the protruding parts 300 down from the upper rib 210 may be formed to be combined with each other by penetrating through the upper filter paper 110. Therefore, the upper filter paper 110, the upper rib 210, and the protruding part 300 are integrally formed and then the edges of the upper filter paper 110 and the lower filter paper 120 are welded to each other to be sealed, such that the upper rib 210 and the protruding part 300 are combined with the filter paper 100.

The communicating pipe 400 is combined with the filter paper 100 to communicate with the space part 130 which is the inside of the filter paper 100, such that the communicating pipe 400 may be combined with the upper filter paper 110. Further, the communicating pipe 400 is also made of a plastic resin material and may be combined by the welding method, and the like to penetrate through the filter paper 110. In this case, the lower end of the communicating pipe 400 disposed in the space part 130 of the filter paper 100 is provided with a plurality of plates which radially protrude, are spaced apart from each other along a circumferential direction, and protrude down from the lower end of the communicating pipe 400 and thus the lower end of the communicating pipe 400 does not contact the lower filter paper 120, thereby smoothing the filtering and injection of fuel.

Therefore, the strainer 1000 according to the exemplary embodiment of the present invention is configured to filter the fuel outside the filter paper 100, suck the fuel into the space part 130 inside the filter paper 100, and then make the fuel flow along the communicating pipe 400.

In this case, the filter paper 100 and the upper rib 210 are partially folded longitudinally and thus the upper and lower portions of the filter paper 100 are formed not to contact each other at the folded portion. That is, as illustrated in FIG. 4, in the state in which the filter paper 100 and the upper rib 210 are partially folded up, the protruding parts 300 support between the upper filter paper 110 and the lower filter paper 120 of the folded and rounded formed portion to maintain the distance between the upper filter paper 110 and the lower filter paper 120.

As described above, the strainer according to the exemplary embodiment of the present invention is formed not to contact the upper and lower filter papers at the folded portion even though the strainer is folded and therefore it is possible to prevent the deposition of filtered materials and the stoppage of the filter paper at the folded portion. Further, the upper rib 210 is combined with the upper portion of the upper filter paper 110 which is the outside of the filter paper 100 and thus the protruding parts 300 protrude down from the upper rib 210, such that the upper rib 210 and the filter paper 100 may be easily folded regardless of the distance between the protruding parts 300 and the upper rib 210 is disposed at the outside of the filter paper 100 and thus the upper filter paper 100 and the upper rib 210 are fixed, being combined with each other, such that it is possible to prevent the upper filter paper 110 from being folded inwardly (toward the space part) at the time of the folding, thereby preventing the upper filter paper 110 and the lower filter paper 120 from contacting each other. Further, the upper rib 210 is provided outside the filter paper 100 and therefore a volume of the space part 130 which is the space inside the filter paper 100 may be increased, thereby reducing a flowing resistance due to the filtering of fuel.

Further, the strainer 1000 according to the second exemplary embodiment of the present invention further includes: a lower rib 220 combined with the outer lower portion of the filter paper 100; and the plurality of protruding parts 300 protruding up from the lower rib 220 to be disposed inside the filter paper 100, in which the filter paper 100, the upper rib 210, and the lower rib 220 may be partially folded longitudinally and thus the upper and lower portions of the filter paper 100 may be formed not to contact each other at the folded portion.

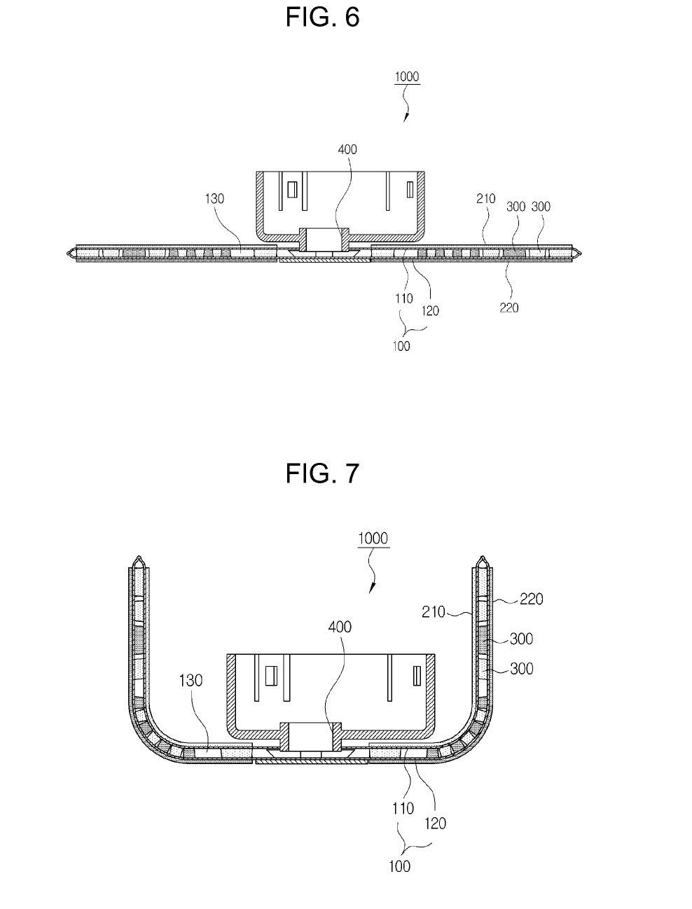

As illustrated in FIGS. 6 to 8, in the strainer according to the first exemplary embodiment of the present invention, the lower rib 220 is additionally combined with the lower surface of the lower filter paper 120 and the protruding part 300 protrudes up from the lower rib 220 and thus the protruding part 300 is configured to be disposed in the space part 130 which is the inside of the filter paper 100.

Therefore, even though the strainer is folded, the form of the filter paper is easily maintained by the upper rib and the lower rib which are each provided with the plurality of protruding parts and the upper and lower filter papers are formed not to contact each other at the portion folded by the protruding parts, such that it is possible to prevent the deposition of the filtered materials and the stoppage of the filter paper at the folded portion.

In this case, the upper rib 210 and the lower rib 220 may be in parallel to be spaced apart from each other in the width direction of the filter paper 100 and the upper rib 210 and the lower rib 220 may be alternately disposed. That is, the upper rib 210 is disposed at a center in the width direction of the upper filter paper 110 and the lower rib 220 is disposed at both sides in the width direction of the lower filter paper 120, such that the upper rib 210 and the lower rib 220 may be formed to be alternately disposed in parallel so as to be spaced apart from each other in the width direction of the filter paper 100.

Therefore, the distance between the upper and lower filter papers at the portion at which the strainer is folded is easily maintained, such that it is possible to prevent the deposition of the filtered materials and the stoppage of the filter paper at the folded portion.

Further, widths W of the protruding parts are each formed differently and distances D between the protruding parts are each formed differently, in which the width W of the protruding part and the distance D between the protruding parts may be narrowly formed at the portion at which the filter paper 100 is folded.

That is, in connection with the plurality of protruding parts 300 protruding down from the upper rib 210, the width W of the protruding part and the distance D between the protruding parts are formed to be narrower at the folded portion than any other portion and thus when the strainer is folded, the lower filter paper 120 is supported by the protruding parts 300 to easily maintain the distance between the upper and lower filter papers. Similar, in connection with the protruding parts 300 protruding up from the lower rib 220, the width W of the protruding part and the distance D between the protruding parts are formed to be narrower at the portion at which the strainer is folded than any other portion and thus when the strainer is folded, the protruding parts 300 are easily support the upper filtering paper 120.

Further, the strainer 1000 according to a third exemplary embodiment of the present invention includes: the filter paper 100 filtering fuel and having the space part 130 disposed therein; an inner rib 230 disposed inside the filter paper 100; the plurality of protruding parts 300 protruding up and down from the inner rib 230 to be disposed inside the filter paper 100; and the communicating pipe 400 combined with the filter paper 100 to communicate with the space part 130 of the filter paper 100, in which the filter paper 100 and the inner rib 230 are partially folded longitudinally and thus the upper and lower portions of the filter paper 100 are formed not to contact each other at the folded portion.

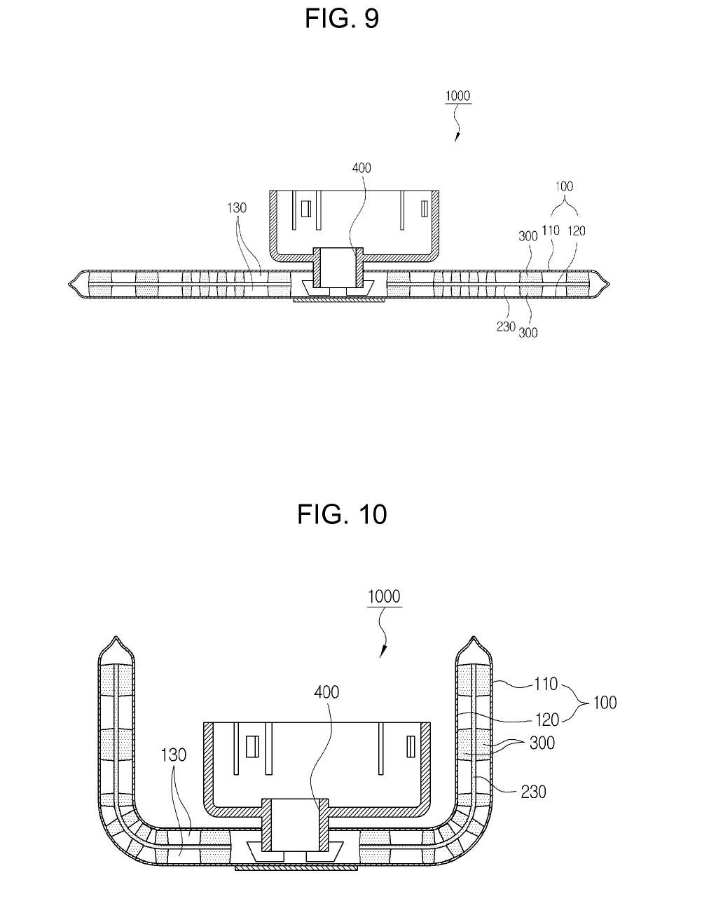

As illustrated in FIGS. 9 to 11, the inner rib 230 is disposed in the space part 130 which is the inside of the filter paper 100, and the upper and lower portions of the inner rib 230 are provided with the plurality of protruding parts 300 and thus the upper filter paper 110 and the lower filter paper 120 are formed at the portion at which the strainer is folded so as not to contact each other. In this case, in the state in which the upper and lower portions of the inner rib 230 are integrally provided with the protruding parts 300, the inner rib 230 is inserted into the space part 130 of the filter paper 100 and then the edge portions of the upper filter paper 110 and the lower filter paper 120 may be sealed by the welding method, and the like.

Therefore, in the strainer according to the third exemplary embodiment of the present invention, the protruding parts 300 disposed on the upper and lower portions of the inner rib 230 support the upper filter paper 110 and the lower filter paper 120, such that the upper filter paper 110 and the lower filter paper 120 may not contact each other.

Further, as illustrated in FIG. 11, in the strainer according to the exemplary embodiment of the present invention, the filter paper 100 is formed in an asymmetrical form and thus may also be formed to be partially folded up.

Further, even in the strainer according to the third exemplary embodiment of the present invention, the widths W of the protruding parts are each formed differently and the distances D between the protruding parts are each formed differently, in which the width W of the protruding part and the distance D between the protruding parts may be narrowly formed at the portion at which the filter paper 100 is folded.

Further, a fuel pump module 2000 according to an exemplary embodiment of the present invention is configured to include the strainer 1000, in which the strainer 1000 is disposed inside a reservoir body 1200 in the partially folded state and the communicating pipe 400 of the strainer 1000 is configured to be connected to an inlet 1110 of the fuel pump 1100 which is disposed inside the reservoir body 1200.

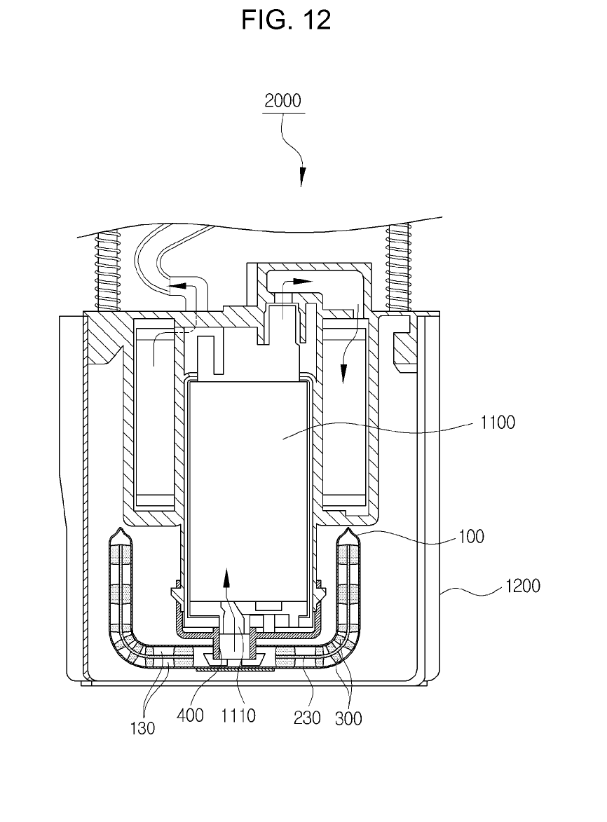

That is, as illustrated in FIG. 12, the fuel pump module 2000 according to the exemplary embodiment of the present invention is disposed inside the fuel tank and thus the fuel inside the fuel tank is partially filled inside the reservoir body 1200, and the communicating pipe 400 of the strainer 1000 is connected to the inlet 1110 of the fuel pump 1100 so that the fuel in the reservoir body 1200 may be sucked into the fuel pump 1100 through the strainer 1000. Therefore, the fuel pump module 2000 may be configured so that the filtered fuel is sucked into the fuel pump 1100 through the lower portion of the strainer 1000 and both sides of the strainer 1000 which is vertically folded.

As described above, the fuel pump module 2000 according to the exemplary embodiment of the present invention is configured so that the upper and lower filter papers are formed not to contact each other at the portion at which the strainer is folded, and thus it is possible to prevent the deposition of the filtered materials and the stoppage of the filter paper at the folded portion.

According to the strainer and the fuel pump module having the same in accordance with the present invention, even though the strainer is folded, the upper and lower filter papers are formed not to contact each other at the folded portion, thereby preventing the deposition of the filtered materials and the stoppage of the filter paper at the folded portion.

The present invention is not limited to the above-mentioned exemplary embodiments but may be variously applied, and may be variously modified by those skilled in the art to which the present invention pertains without departing from the gist of the present invention claimed in the claims.

What is claimed is:

1. A strainer, comprising:
a filter paper filtering fuel and having a space part disposed therein;
an upper rib combined with an outer upper portion of the filter paper;
a plurality of protruding parts protruding down from the upper rib to be disposed inside the filter paper; and
a communicating pipe combined with the filter paper to communicate with the space part of the filter paper,
wherein the filter paper and the upper rib are partially folded up longitudinally, the folded portion is formed in a rounded form, and the upper and lower portions of the filter paper are formed not to contact each other at the folded portion.

2. The strainer of claim 1, further comprising:
a lower rib combined with the outer lower portion of the filter paper; and
the plurality of protruding parts protruding up from the lower rib to be disposed inside the filter paper;
wherein the filter paper, the upper rib, and the lower rib are partially folded longitudinally and thus the upper and lower portions of the filter paper are formed not to contact each other at the folded portion.

3. The strainer of claim 2, wherein the upper rib and the lower rib are disposed in parallel to be spaced apart from each other in the width direction of the filter paper and the upper rib and the lower rib are alternately disposed.

4. The strainer of claim 1, wherein widths W of the protruding parts are each formed differently and distances D between the protruding parts are each formed differently, and the width W of the protruding part and the distance D between the protruding parts are more narrowly formed at the portion at which the filter paper is folded than at the portion at which the filter paper is not folded.

5. The strainer of claim 2, wherein widths W of the protruding parts are each formed differently and distances D between the protruding parts are each formed differently, and the width W of the protruding part and the distance D between the protruding parts are more narrowly formed at the portion at which the filter paper is folded than at the portion at which the filter paper is not folded.

6. The strainer of claim 3, wherein widths W of the protruding parts are each formed differently and distances D between the protruding parts are each formed differently, and the width W of the protruding part and the distance D between the protruding parts are more narrowly formed at the portion at which the filter paper is folded than at the portion at which the filter paper is not folded.

7. A strainer, comprising:
a filter paper filtering fuel and having a space part disposed therein;
an inner rib disposed inside the filter paper;
a plurality of protruding parts protruding up and down from the inner rib to be disposed inside the filter paper; and
a communicating pipe combined with the filter paper to communicate with the space part of the filter paper,
wherein the filter paper and the inner rib are partially folded up longitudinally, the folded portion is formed in a rounded form, and the upper and lower portions of the filter paper are formed not to contact each other at the folded portion, and
widths W of the protruding parts are each formed differently and distances D between the protruding parts are each formed differently, and the width W of the protruding part and the distance D between the protruding parts are more narrowly formed at the portion at which the filter paper is folded than at the portion at which the filter paper is not folded.

8. A fuel pump module, comprising:
the strainer of claim 1,
wherein the strainer is disposed inside a reservoir body in a partially folded state and a communicating pipe of the strainer is connected to an inlet of the fuel pump which is disposed inside the reservoir body.

9. A fuel pump module, comprising:
the strainer of claim 7,
wherein the strainer is disposed inside a reservoir body in a partially folded state and a communicating pipe of the strainer is connected to an inlet of the fuel pump which is disposed inside the reservoir body.
